(19) United States
(12) Patent Application Publication
(10) Pub. No.: US 2002/0116632 A1
(43) Pub. Date: Aug. 22, 2002

(54) Tamper-resistant computer system

(75) Inventors: Shinji Itoh, Yokohama (JP); Hiroshi Yoshiura, Tokyo (JP); Hiroo Okamoto, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/005,713

(22) Filed: Nov. 7, 2001

(30) Foreign Application Priority Data
Feb. 22, 2001 (JP) 2001-045949

(51) Int. Cl. H04L 9/00

(52) U.S. Cl. 713/200; 380/277

(57) ABSTRACT

A system and method for realizing a tamper-resistant system which can prevent software running on a personal computer from being analyzed or altered illegally in a static or dynamic manner by a potential transgressor. Two operating systems, an OS1 controllable by a user and an OS2 operable in background, are concurrently run on a personal computer. Player software is run on the OS2 to protect the player software against illegal analysis and alteration by the user. Further, a hardware module, a system startup, and a key management operation are implemented. Still further, OS1 cannot direct access OS2, whereas indirect access of OS2 by OS1 is allowed in a manner whereby OS2 refers to an OS2 reference region in a memory area managed by OS1.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to a technique for preventing illegal analysis and alteration of software used on a computer to assure high-level security protection. More specifically, the present invention relates to a technique and system for preventing illegal analysis and alteration of computer software to protect copyrighted material on a device used to play digital contents.

A device for playing digital contents, including motion pictures, still pictures and music, uses dedicated hardware or player software having a copyright protection function. For player software having a copyright protection function, a general-purpose computer, such as a personal computer (herein referred to simply as a PC), is typically used as a player device. Therefore, the example presented here describes a situation where a PC is used to play digital contents.

In the use of dedicated hardware having a copyright protection function, digital contents are encrypted before distribution. When each user receives the encrypted digital contents, decryption is performed through a tamper-resistant module for preventing illegal analysis and alteration in an authorized player device. Then, additional information, such as the conditions for use of the program, is read out, and the decrypted digital contents are played only if those conditions are satisfied.

If digital contents are played on a PC a software program having a copyright protection function is often employed. More specifically, in one method of streaming digital content, the digital content is not stored on a user's PC. In an alternative method, encrypted digital content is stored on the user's PC, and then, at the time of playback, it is decrypted and the conditions for use are read out for confirmation in the same manner as in the use of the dedicated hardware.

To prevent the copyright protection function of player software from being altered or illegally analyzed, the software is stored as an encrypted file, or as a hidden file. When player software is stored as an encrypted file, decryption is performed in an internal memory at the time of execution. If the player software is stored as a hidden file, the contents thereof are loaded into internal memory at the time of execution. In either of these methods, unauthorized analysis of internal memory can be conducted at the time of execution.

For protection against illegal copying, digital contents are stored similarly to the player software mentioned above, as an encrypted file or as a hidden file. In either method, illegal copying of the digital contents can still be conducted, as is the case with the player software.

On a common type of PC, a person having a certain level of expertise in electronic computing can analyze or tamper with a player software program stored on a hard disk, or on any other storage medium, by probing the operating system (OS) running on the PC or by using another software program on the PC. It is therefore possible to duplicate digital contents having protection against illegal copying or to infringe the conditions for use thereof. It is also possible to tamper with digital contents authorized for use only by a particular person so that another person can use them. A copyright on player software or digital contents could thus be infringed.

Where dedicated hardware is used for playing digital contents, a copyright thereon can be securely protected. However, when a portable device is redesigned or upgraded, a user must replace it with a new-model portable device to use new additional functions incorporated therein, increasing the cost of playing back digital contents. Because rapid advances in the functionality of dedicated hardware are expected, it is economically disadvantageous for each user to successively replace hardware models to use the latest functions.

### BRIEF SUMMARY OF THE INVENTION

The present invention provides a technique for securely protecting copyrighted digital contents in a digital content player system (hereinafter referred to as a “system”) that uses player software for playing digital contents on a general-purpose computer, such as a PC. The present invention provides a technique and system for making player software used on a general-purpose computer, such as a PC, resistant to illegal or unauthorized analysis and alteration.

According to one aspect of the present invention, the following computer system configuration is provided: two independent operating environments, which are a first environment (1) for user interface processing and a second environment (2) for protection against illegal tampering, and a communication function for connecting these environments are arranged on a general-purpose computer, such as a PC. Individual process units (programs), each of which runs on each of the environments, run cooperatively to constitute application software (e.g., player software).

To preclude illegal tampering, the present invention provides a communication control function for limiting communications from environment 1 to environment 2, and from environment 2 to environment 1. More specifically, the following operations are carried out:

In communication from environment 1 to environment 2, player software in environment 1 writes a command or information to be transferred into a specific memory region that has been allocated for the purpose of communication. Then, by evoking the specific memory region, the program in environment 2 receives the command or information from environment 1. Environment 2 has a list of commands or information permitted for processing therein, and, according to this list, each of the permitted commands or information is processed in environment 2.

In communication from environment 2 to environment 1, the program in environment 2 writes a command or information into a specific memory region. Then, by evoking the specific memory region, the program in environment 1 receives the command or information for carrying out processing. Since the program in environment 2 is in control, as mentioned above, protection is ensured against illegal tampering by a malicious user even if it is attempted through environment 1.

More specifically, environments 1 and 2 are respectively managed by two independent operating systems (OSs) of each environment. The present invention introduces a multi-OS control program for running the two OSs on an apparatus and for controlling OS-to-OS communication. The multi-OS control program allocates an independent memory area to each of the OSs in such a manner that direct access from one OS to the other OS is not allowed. Each OS in the present invention has a process control function, a process scheduling function, an interrupt control function, and a memory management function. The present invention is thus applicable to any software having these functions, and is not limited to a conventional OS.

With regard to application software, such as player software, environment 1 provides a user interface component for receiving input information, such as operational instructions from a user, and for delivering output messages to the user; and environment 2 provides a command processing component (including a player control component) for carrying out operational instructions input from the user. The user interface component in environment 1 receives each operational instruction from the user, and then, through a communication control function, such as mentioned above, for controlling communication between environments 1 and 2, the user interface component transfers the operational instruction to the player control component in environment 2. Then, the command processing component in the environment 2 carries out processing as instructed by the user.

The user gets the application software by means of a removable storage medium, such as a CD-ROM, or from a server, through a network, by using a communication medium.

Before installation into a PC, the application software has a component program to be run in environment 1, a component program to be run in environment 2, and a digital signature. When the application software is to be installed in the PC, the component program executable in environment 1 issues an installation command to environment 2 by using the above-mentioned communication method between environments 1 and 2. Environment 2 authenticates the application software by verifying the digital signature, and the application software is installed so that the software can be used on the PC.

For system startup, system installation, permission for application software operation, and permission for digital contents playback, the present invention provides a tamper-resistant hardware module which is operatively associated with the PC to prevent unauthorized internal analysis and alteration of physical and logical elements. For example, an add-in PC board or an IC card (smart card) can be used as this tamper-resistant hardware module.

The player software may be partially or wholly encrypted. Before using the partially or wholly encrypted player software, the user obtains a decryption key. For example, a communication path is set up between the PC and a server supplying the decryption key, and after user authentication, the hardware module receives the decryption key from the server via the PC through the communication path. The hardware module receives a decryption command and decrypts the player software in environment 2.

Because the player software is usually stored on a device such as a hard disk, the portion of player software stored thereon may be encrypted to prevent unauthorized static analysis. Further, by adding a digital signature to the player software, unauthorized tampering therewith can be prevented. When the portion of the player software stored on the storage device is encrypted, a decryption key may be stored in the hardware module.

Digital content to be processed by the player software is distributed to each user in an encrypted form, as required. The user obtains a decryption key for the encrypted digital contents in the same way the decryption key for the encrypted player software was obtained, and then the digital contents are stored in the hardware module. The digital contents may also be stored in environment 1 or 2 instead of in the hardware module.

In the operation to access a cryptographic key for the player software or digital contents stored in the hardware module, the hardware module and the player software operating in environment 2 perform authentication using a digital signature. Only after authentication can the player software access the hardware module. Thus, illegal extraction of information from the hardware module can be prevented.

To ensure normal system startup, a boot program having a tamper-resistant feature is also prestored in the above-mentioned hardware module. At system startup, an authentication program is loaded into the PC's internal memory. After the authentication program determines that no unnecessary process (e.g., an illegal analysis program) is active in the internal memory, the boot program is loaded into internal memory for execution. When the boot program is executed, the multi-OS control program and system files OS1 and OS2 are loaded into internal memory from the hard disk. As required, a key for decrypting an encrypted system file is extracted from the hardware module, and the encrypted system file is decrypted on the internal memory. After decryption, the initial settings for each OS are input for system startup.

In the method above, memory access and analysis are inhibited or restricted during execution of the player software. Thus, unauthorized alteration and analysis of the player software can be prevented, and a copyright on digital contents can be protected. Where a removable storage medium, such as an IC card (smart card), is used as a hardware module, digital contents for which playback rights have been granted to each user can be played on another portable device having a system of the present invention by setting the hardware module thereon.

Although player software for digital contents has been used as an example in the foregoing description, it is to be understood that the present invention is not limited thereto. The present invention is also applicable to any OS-executable application software that could otherwise be subjected to illegal or unauthorized use, alteration or analysis.

These and other benefits are described throughout this specification. A further understanding of the nature and advantages of the invention may be realized by reference to the remaining portions of the specification and the attached drawings.

### BRIEF DESCRIPTION OF THE DRAWINGS

FIG. 1 is a diagram of the entire configuration of a tamper-resistant software system according to the preferred embodiment;

FIG. 2 is a diagram of a structure of system installation software;

FIG. 3 is a flowchart of a processing sequence to be performed for system startup;

FIG. 4 is a diagram of a method of communication between OS1 and OS2;

FIG. 5 is a diagram of a structure of a hardware module;

FIG. 6 is a diagram of a structure of distribution software;

FIG. 7 is a diagram of a procedure to be performed for getting a software key;

FIG. 8 is a flowchart of a processing sequence to be performed for software installation;

FIG. 9 is a diagram showing software stored in hard disks;

FIG. 10 is a flowchart of a processing sequence to be performed for software startup;

FIG. 11 is a diagram of a procedure to be performed for getting a contents key;

FIG. 12 is a diagram showing operations used for playing digital contents; and

FIG. 13 is a flowchart of a processing sequence to be performed for system installation.

### DETAILED DESCRIPTION OF THE PREFERRED EMBODIMENTS

Outline of System

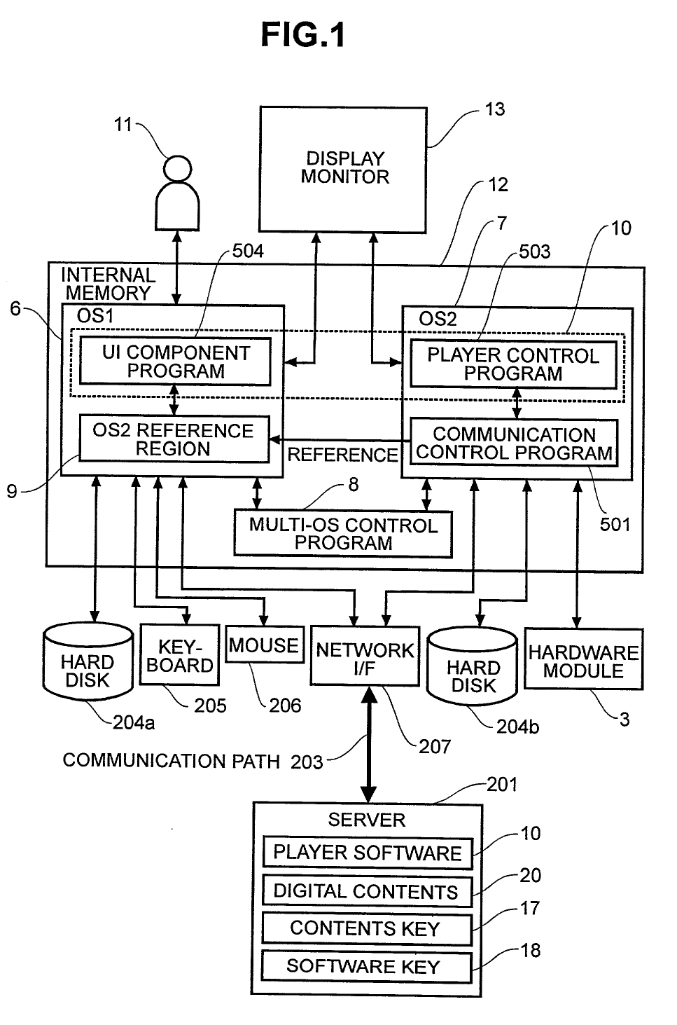

FIG. 1 shows an exemplary configuration of a system in a preferred embodiment. In this system, a multi-OS control program 8 presides over two operating systems, OS1 and OS2, on a PC. Reference numeral 12 indicates an internal memory on the PC, reference numeral 6 indicates a memory area managed by OS1, and reference numeral 7 indicates a memory area managed by OS2. An area in the PC's memory is allocated for carrying out the multi-OS control program 8. OS1 manages a hard disk 204a, a keyboard 205 and a mouse 206, and OS2 manages a hard disk 204b and a hardware module 3. A display monitor 13 under exclusive control of multi-OS control program 8, can be used for display by both OS1 and OS2. Further, in a modified arrangement, a speaker that can be used for output by both OS1 and OS2 may be provided. Reference numeral 10 indicates player software that has a user interface (UI) component program 504, a player control program 503, and a configuration file.

Multi-OS control program 8 is designed for controlling a plurality of OSs on the PC, and, more specifically, the multi-OS control program carries out initialization and partition-occupancy processing for each hardware part, CPU scheduling for each OS, and interrupt processing.

Each OS has a table for conversion from virtual addresses to physical addresses (also referred to as a page table). In Japanese Patent Application Laid-open No. 11-149385, discloses a technique in which a multi-OS control program performs a table changeover for running a plurality of OSs on a PC without emulation of privileged instructions (used for setting protection and memory management functions executable only by an OS). Further, as a method for concurrently running a plurality of OSs on a PC, a virtual machine system technique is known in which PC hardware emulation is performed. Based on these techniques, the present invention can be practiced as described below.

In the preferred embodiment, a first operating system OS1 provides functions to be operated directly by a user 11, whereas a second operating system OS2 does not provide user-operated functions. Further, because OS-to-OS communication control is implemented, there is no function for direct access to OS2 from OS1. These arrangements prevent user 11 from identifying details of software running on OS2. Thus, dynamic analysis, such as tampering with software running on OS2, can be prevented.

In the system configuration described above, player control program 503 of player software 10, which is not to be analyzed by user 11, is run on OS2 for carrying out player operation control, and UI component program 504 is run on OS1 for receiving operational information from user 11. Since OS1 cannot refer to the memory area managed by OS2, user 11 is prevented from learning how player control program 503 runs. User 11 is allowed to know only information provided by UI component program 504.

Communication Between OS1 and OS2

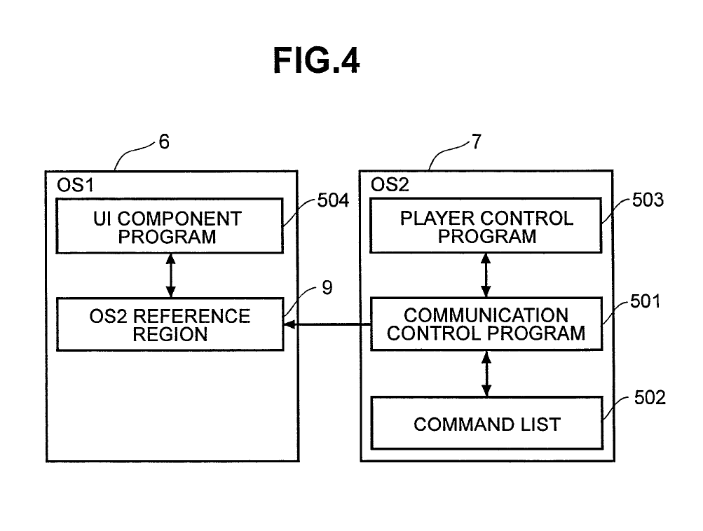

Referring to FIG. 4, communication between the respective environments managed by OS1 and OS2 is carried out by communication control program 501. For OS-to-OS communication, communication control program 501 refers to the contents of an OS2 reference region 9. At system startup, the multi-OS control program 8 performs memory mapping of OS2 reference region 9 in OS1 to provide a page table to be used by OS2. Thus, communication control program 501 can refer to the OS2 reference region 9. Communication control program 501 checks a command list 502 against information written in OS2 reference region 9 by UI component program 504. More specifically, in OS2 reference region 9, the UI component program 504 writes information regarding player control program 503 (program name for information transfer) and control information. If, as a result of checking command list 502, it is found that an input command matches one of the commands contained in the command list, the input command is transferred to player control program 503, which corresponds to UI component program 504. Note that it is not necessarily required to provide a one-to-one correspondence for the UI component program 504 and player control program 503.

Command list 502 contains commands that have been written by player control program 503 running on OS2 at startup, and execution requests from OS1 are permitted only for these commands. Any command from software that is not running on OS2 is not contained in command list 502. If an input command does not match any of the commands contained in command list 502, an error message is issued to UI component program 504 through a communication procedure from OS2 to OS1 (to be described in detail later). UI component program 504 provides the user with a visual or audible error indication using a function of OS1.

The contents of command list 502 vary according to the player control program running on the OS2. Each time player control program 503 is started up, command list 502 is rewritten by player control program 503. When player control program 503 is terminated, commands associated with the player control program are removed from command list 502.

During communication from OS2 to OS1, communication control program 501 receives information from player control program 503; then communication control program 501 writes the information into OS2 reference region 9. UI component program 504 obtains the information from OS2 by referring to the contents of OS2 reference region 9.

In another embodiment, command list 502 may be provided in advance for each of player control programs 503. Thus, communication control program 501 can conduct communication control through comparative checking of the command lists 502. It is preferable that the command list 502 should be stored in an encrypted form on a storage device such as a hard disk device. Further, a technique for communication between different types of OSs, disclosed in Japanese Patent Application Laid-open No. 11-085546, which is hereby incorporated by reference for all purposes, is also applicable.

Features and Functions of Hardware Module

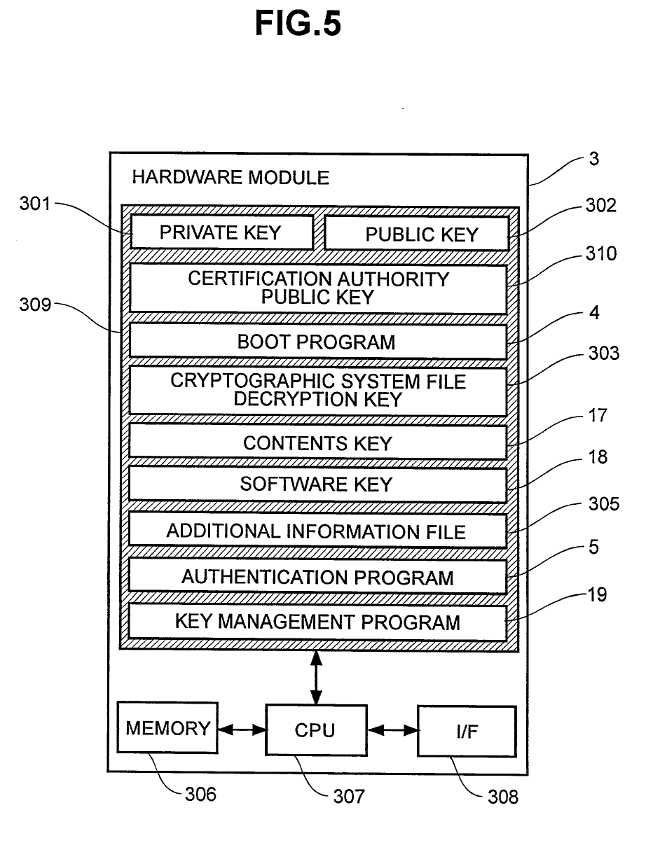

Hardware module 3 is a tamper-resistant hardware module, protected against unauthorized internal analysis and alteration of the physical and logical elements thereof. FIG. 5 shows an exemplary structure of hardware module 3. A nonvolatile memory domain 309 of hardware module 3 stores a private key 301 unique to the hardware module in public key cryptography, a public key 302 corresponding to the private key, a certification authority public key 310, a boot program 4 for launching the multi-OS control program 8, a cryptographic system file decryption key 303, an authentication program 5, a key management program 19, a contents key 17, a software key 18, and an additional information file 305.

Contents key 17 is used for decrypting encrypted digital contents, and software key 18 is used for decrypting encrypted player software. Information such as the use period and conditions for use of contents key 17 and software key 18 is written in additional information file 305. Moreover, hardware module 3 has a CPU 307, a memory 306, and an interface 308 for external communication. Using these components, hardware module 3 processes external input. In a modified arrangement, digital contents may be stored in nonvolatile memory domain 309.

In operations involving external access to information stored in hardware module 3, except at PC startup, the hardware module sends authentication program 5 to internal memory 12 of the PC. Then, on internal memory 12, a software program attempting access to hardware module 3 is examined for authentication. Public key 302 or certification authority public key 310 is used for the authentication operation. If authentication is successful, hardware module 3 sends information needed for further access to the software program concerned. If the authentication is not successful, the hardware module sends an error message to the software program concerned.

When access to hardware module 3 is sought at the PC startup, hardware module 3 sends authentication program 5 to internal memory 12 of the PC, and then the authentication program determines whether or not any unnecessary process is active on the PC's internal memory 12. If no unnecessary process is active, boot program 4 is extracted from hardware module 3 for booting up the PC. If an unnecessary process is active, the startup is aborted.

More specifically, authentication program 5 carries out a CPU register check on the PC to determine whether an interrupt-disabled state (interrupt-inhibited state) is set. If the interrupt-disabled state is set, boot program 4 is extracted from hardware module 3 for execution. If the interrupt-disabled state is not set, the startup is aborted.

In addition, limitations are imposed on information extraction by each software program attempting access to hardware module 3. For this purpose, hardware module 3 includes a table indicating information contained in the hardware module and identifiers of software programs which are permitted to extract that information. Using this table, key management program 19 imposes limitations on information extraction by each software program.

Key management program 19 generates a temporary session key at random for the purpose of obtaining a contents key 17 or a software key 18 from a server 201. Further, key management program 19 carries out decryption of encrypted data, authentication using a digital signature, and a key management operation described below.

A private key 301, unique to each hardware module 3, is used to pass the contents key 17 or the software key 18 for decrypting encrypted application software or encrypted digital contents. Because private key 301 and the public key 302 corresponding thereto are used, contents key 17 or software key 18 can be delivered in an encrypted form unique to each hardware module. Thus, illegal use of the application software and digital contents can be prevented, and it is also possible to provide different services to individual users. Key management program 19 does not provide a command function for outputting private key 301 outside hardware module 3, thus preventing private key 301 from being accessed externally.

Instead of including all the above-described functions in one hardware module 3, a plurality of hardware modules 3 may be used to contain each group of functions. For example, in an alternative arrangement hardware module 3 is divided into two modules: hardware module 3A, which includes a group of functions regarding system startup (boot program 4, authentication program 5, key management program 19, cryptographic system file decryption key 303), and a hardware module 3B, which includes a group of functions regarding key management for encrypted application software and encrypted digital contents (authentication program 5, private key 301, public key 302, contents key 17, software key 18, key management program 19, additional information file 305).

Hardware module 3B for management of the contents key 17 and the software key 18 may be provided in a removable type of storage medium such as an IC card. Thus, on one PC to be used by a plurality of users, different digital contents can be played for individual users. It is also possible to play digital contents on another PC having the system of the preferred embodiment by adding to it a removable hardware module 3B.

Key Management

Key management program 19 resides in the hardware module and manages contents key 17, software key 18 and cryptographic system file decryption key 303 (hereinafter “decryption key 303”). The key management program uses additional information file 305, which contains the usage conditions for contents key 17 and software key 18. For example, on expiration of the use period of a key, key management program 19 removes the key so that digital contents and application software corresponding to the key become unavailable.

Through the use of the above-mentioned feature, it is possible to provide a free introductory service whereby each potential customer may play digital contents or use all the software functions for a trial period. Because contents key 17, software key 18 and additional information file 305 are managed in hardware module 3, illegal tampering therewith by a user can be prevented.

System Installation

For installation of the system of the preferred embodiment, hardware module 3 is connected to an external interface (e.g., universal serial bus (USB), PC card, add-in board) equipped on a common-type PC owned by user 11. Then, system installation is carried out using system installation software 14 contained in a storage medium such as a CD-ROM.

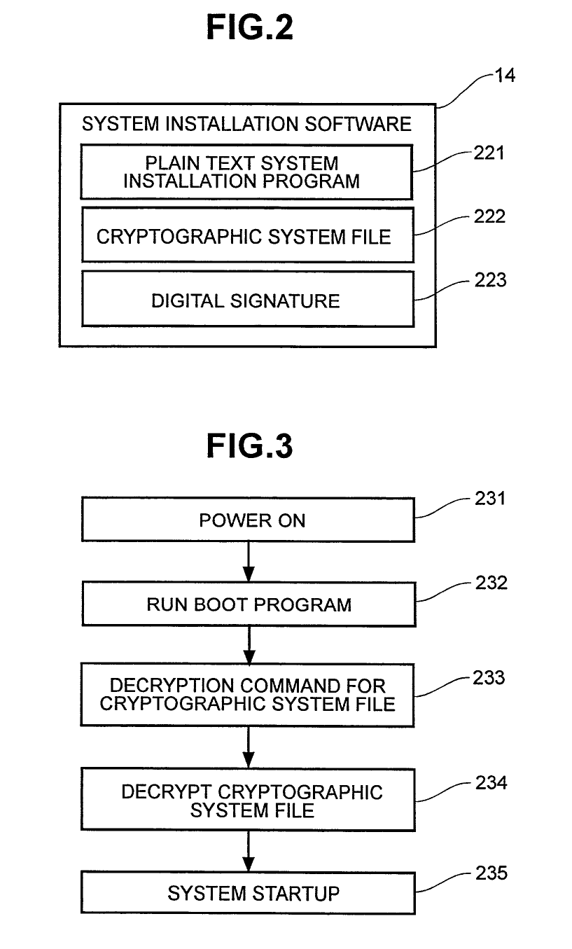

Referring to FIG. 2, there is shown an exemplary structure of system installation software 14. System installation software 14 has a plain text system installation program 221 (hereinafter “installation program 221”), a cryptographic system file 222, and a digital signature 223. Installation program 221 includes a function for terminating an active unnecessary process, a function for partitioning hard disk 204, and a function for installing the system of the preferred embodiment. Cryptographic system file 222, which is wholly or partially encrypted, contains multi-OS control program 8 and OS2. The cryptographic system file may also contain OS, 1 if required. Digital signature 223 is used to verify that the system installation software has not been tampered with. This verification can be carried out with public key 302. For system installation, user 11 needs to [access?] hardware module 3, which contains public key 302.

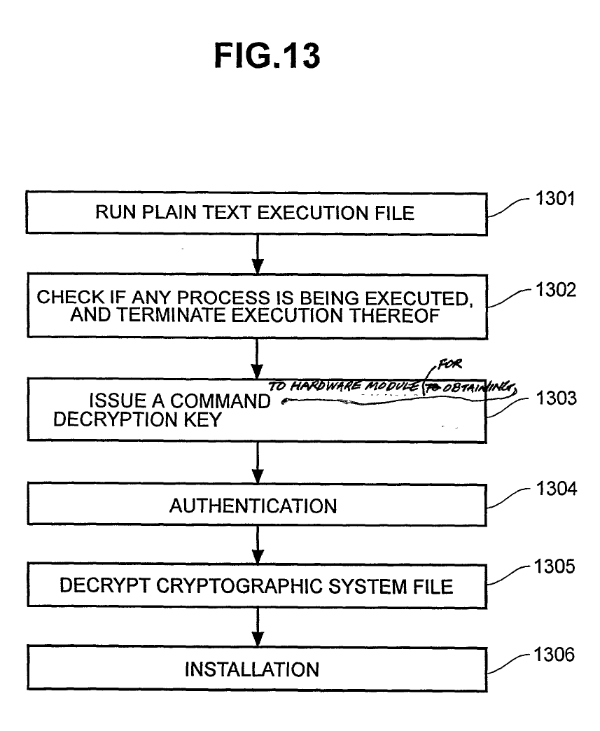

FIG. 13 is a system installation flowchart.

At step 1301, user 11 executes installation program 221 for the PC, thus starting system installation.

At step 1302, installation program 221 checks whether any process is active, and terminates any unnecessary active process so that sensitive information cannot be stolen during installation.

At step 1303, installation program 221 issues a command to hardware module 3 for obtaining decryption key 303.

At step 1304, before executing the command received from installation program 221, hardware module 3 sends authentication program 5 to the internal memory of the PC. Authentication program 5 calculates the hash values of installation program 221 and cryptographic system file 222, and sends the calculation results and digital signature 223 to hardware module 3. Then, key management program 19 performs authentication using the calculation results, digital signature 223, and public key 302. If the authentication is successful, decryption key 303 is passed to installation program 221, and control goes to the next step. If the authentication is not successful, an error message is given to installation program 221 to abort system installation.

At step 1305, installation program 221 decrypts cryptographic system file 222 using decryption key 303. At step 1306, installation program 221 carries out system installation with reference to configuration file data contained in the decrypted cryptographic system file 222. In an alternative arrangement, a system installation program may reside in cryptographic system file 222. Thus, after decryption of cryptographic system file 222, the system installation program contained therein can be used for carrying out system installation.

Installation program 221 creates partitions on hard disk 204 to be allocated as storage areas for OS1 and OS2. All the information including the data OS1 held on the hard disk before introduction of the system of the present invention is stored in area 204a, allocated to OS1, and OS2 is stored in area 204b, which is allocated to OS2. Multi-OS control program 8 may be written in either of the areas 204a and 204b allocated to OS1 and OS2, or multi-OS control program 8 may be written in a newly allocated storage area. When a PC having a plurality of hard disk drives is used, areas 204a and 204b may be allocated to different drives without further partitioning of the hard drive. To prevent illegal analysis and alteration by a user, multi-OS control program 8 and OS2 are preferably written in a wholly or partially encrypted form on the hard disk. Further, OS1 may also be written in an encrypted form on the hard disk. For normal startup of the system, installation program 221 writes boot program 4 in hardware module 3. A program and other necessary startup information from hardware module 3 are written in a master boot record on the hard disk.

While installation of the system of the preferred embodiment is based on the condition that the OS1 has been installed in the PC in advance, it is also possible to introduce the system of the preferred embodiment even if the OS1 has not been installed in advance. Moreover, the above-mentioned installation method is not limited to installation of the system of the preferred embodiment, but is applicable to installation of an OS on each PC.

System Startup

FIG. 3 is a flowchart of system startup in the preferred embodiment. At steps 231 and 232, when the user turns on power to the PC, the CPU of the PC calls up a program (initial program) in the master boot record on the hard disk. This program loads authentication program 5 held in hardware module 3 onto the internal memory of the PC. Then, authentication program 5 checks whether any unnecessary process is active on the internal memory of the PC. If an unnecessary process is active, the system startup is aborted. If no unnecessary process is active, authentication program 5 reads boot program 4 from hardware module 3 into the internal memory of the PC for execution of the boot program.

In particular authentication program 5 carries out a CPU register check on the PC for to determine whether an interrupt-disabled state (interrupt-inhibited state) is set. If an interrupt is disabled, authentication program 5 continues to run and reads boot program 4 from hardware module 3 into the internal memory of the PC for execution. If the interrupt-disabled state is not set, the startup is aborted.

Because authentication program 5 checks to ensure that no unnecessary process is active, i.e., determines whether an interrupt is disabled as mentioned above, it is possible to prevent a potential transgressor from altering the master boot record to call up authentication program 5, for example, after executing a boot monitoring program or the like. Thus, theft of sensitive information (e.g., the decryption key) is prevented.

At steps 233 and 234, boot program 4 loads the cryptographic system file from the hard disk into the internal memory of the PC, and then takes the decryption key 303 out of hardware module 3 to decrypt the cryptographic system file. At step 235, multi-OS control program 8 allocates memory areas for OS1 and OS2 and places system files from OS1 and OS2 in their respective memory areas. The multi-OS control program then executes an OS-to-OS changeover. Each OS, after taking control, carries out initial setting and loads necessary programs and data into the internal memory. Thus, the system startup is complete, and the PC is ready for operation and user input on OS1.

Structure of Player Software before Installation

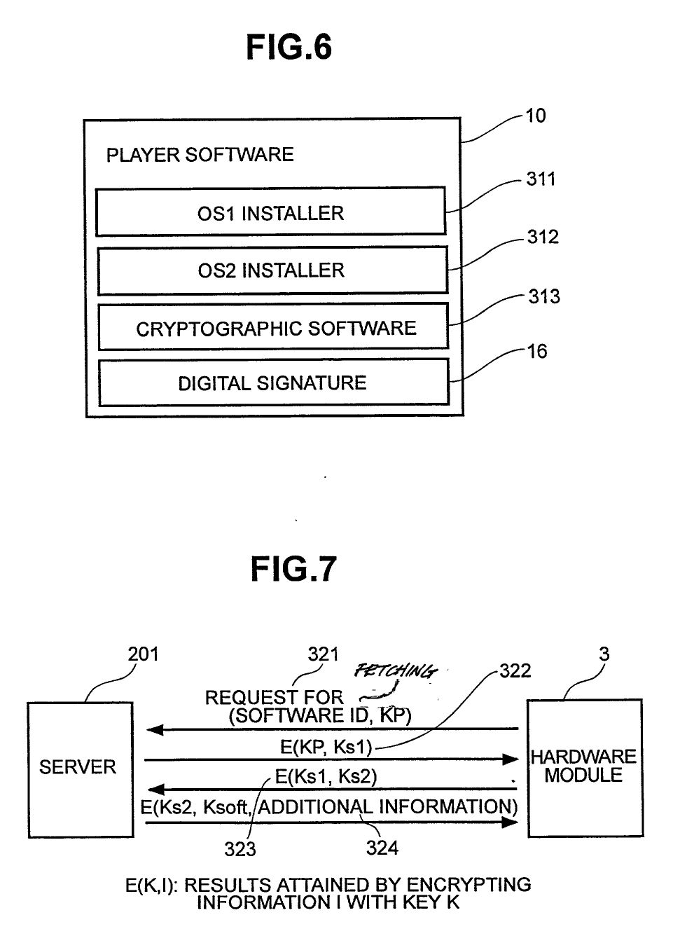

A part of the player software 10 used in the system of the preferred embodiment is encrypted in advance with a unique key. FIG. 6, shows an exemplary structure of player software 10 before installation. Player software 10 has an OS1 installer 311, an OS2 installer 312, cryptographic software 313, and a digital signature 16. OS1 installer 311, which is run on OS1, has a function for issuing a request for installing player software 10. OS2 installer 312, which is run on OS2, has a function for extracting software key 18 from hardware module 3. Cryptographic software 313 is used for installing player software 10 on OS2.

Each of OS1 installer 311, OS2 installer 312 and cryptographic software 313 has a plurality of files including a program file, data file and configuration file. It is necessary to encrypt cryptographic software 313 wholly; i.e., only the sensitive part of the cryptographic software may be encrypted, or cryptographic software 313 may be partially encrypted for imposing limitations on usage and functionality. Further, it is not necessary to use a common encryption key; i.e., a different encryption key may be used for each file or each function included in player software 10. Digital signature 16 is used for detecting an illegal alteration in player software 10. In a situation where only player software 10 is to be protected against an illegal alteration, it is not necessary to encrypt the player software, and digital signal 16 is used for detecting an illegal alteration therein.

Player software 10 in the system of the preferred embodiment may be distributed through a network such as the Internet or by means of a removable storage medium, in the same manner as for other existent software.

Although the player software is used as an example in the preferred embodiment, it is to be understood that the present invention is applicable to any other software to be protected against illegal analysis and alteration.

Getting the Software Key

FIG. 7 shows a procedure for getting software key 18. This procedure is performed when player software 10 is installed, or when it becomes necessary to decrypt an encrypted portion of player software 10. At step 321, player software 10 sends server 210 public key 302 (KP), which is unique to the hardware module 3; public key certificate information, which may be stored together with the public key 302; and the ID information for player software 10.

Then, using the public key certificate information, server 201 verifies hardware module 3 for authentication. At step 322, server 201 generates a temporary session key Ks1 (symmetric key) and sends data encrypted using the received public key 302 (KP) to the PC of user 11. On the PC of user 11, player software 10 receives the encrypted data and delivers it to hardware module 3.

At step 323, the key management program 19 in hardware module 3 decrypts the encrypted data using private key 301 to obtain session key Ks1, generates a temporary session key Ks2 (symmetric key), encrypts session key Ks2 using session key Ks1, and sends encrypted session key Ks2 to server 201.

At step 324, server 201 decrypts encrypted session key Ks2 using session key Ks1 to obtain session key Ks2, encrypts software key 18 (Ksoft) and additional information (such as the conditions for use) using session key Ks2, and sends encrypted software key 18 (Ksoft) and additional information to the PC of user 11.

When server 201 is required to send only software key 18 (Ksoft), server 201 may encrypt software key 18 (Ksoft) using public key 302 (KP) and send the encrypted software key 18 (Ksoft) to the PC of user 11. On the PC of user 11, player software 10 writes the received data into hardware module 3 or onto the hard disk of the PC. When the received data is written into hardware module 3, encryption is not necessary;, therefore in hardware module 3, the received data may be decrypted using session key Ks2 and stored in hardware module 3.

In contrast, when the received data is written onto the hard disk of the PC, an encrypted form thereof is stored on the hard disk, while session key Ks2 is stored in hardware module 3. In this case, there may be provided an arrangement whereby encrypted software key 18 (Ksoft) and additional information are decrypted once using the session key Ks2 and then a new key is generated for re-encrypting software key 18 (Ksoft) and additional information.

Installation of Player Software

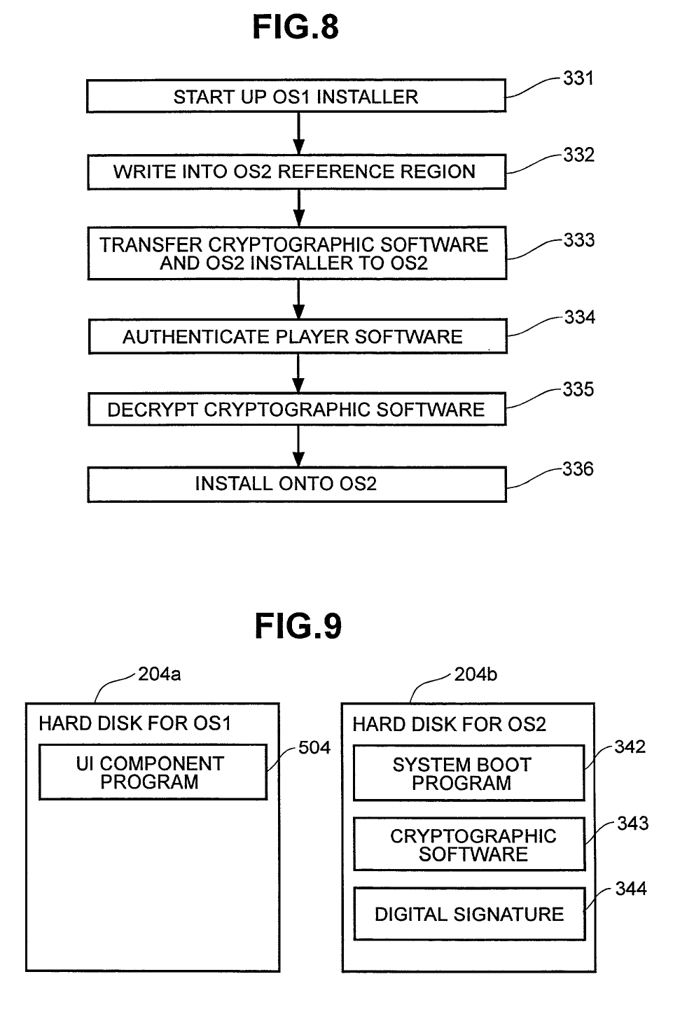

A processing flow for installation of player software 10 is now described with reference to FIGS. 6 and 8. At step 331, user 11 starts up OS1 installer 311. Then, at step 332, OS1 installer 311 writes a command for installing player software 10 into OS2 reference region 9 in the OS1 memory area. This installation command includes a file transfer/copy command function necessary for installing the player software residing in the OS1 memory area onto the OS2, and a command function for activating OS2 installer 312.

At step 333, communication control program 501 carries out the installation command with reference to OS2 reference region 9. and player software 10 is installed onto the OS2 memory area. At step 334, OS2 installer 312 asks hardware module 3 whether the hardware module has the software key 18 corresponding to the player software to be installed. At this step, hardware module 3 sends authentication program 5 to the PC's internal memory 12, and authentication program 5 calculates a hash value of player software 10 and sends the calculated hash value to hardware module 3 together with digital signature 16.

Using the calculated hash value, certification authority public key 310, and digital signature 16, key management program 19 authenticates the player software. If authentication is successful, the inquiry from OS2 installer 312 is accepted. If authentication is not successful, an error message is returned to the OS2 installer. In an alternative arrangement, authentication program 5 may be provided in the OS2 memory area in advance. Thus, when a request for access to hardware module 3 takes place, authentication program 5 can immediately perform authentication of player software 10.

If the hardware module 3 does not have software key 18, OS2 installer 312 gets the software key from server 201 and passes the software key to hardware module 3. Thereafter, OS2 installer 312 sends a command for decryption to the hardware module.

If hardware module 3 has software key 18, OS2 installer 312 sends a command for decryption to the hardware module without issuing an inquiry to server 201. At step 335, hardware module 3 sends the corresponding software key 18 to OS2 installer 312, and then the OS2 installer carries out decryption. In the main part of the player software 10, only data necessary for installation is decrypted while the remaining data is left in an encrypted form. There may also be provided an arrangement where decryption is performed once to generate a new key and then re-encryption is performed using the new key. In a situation where player software 10 is provided in non-encrypted form or when decryption is not required at the time of installation, authentication is made using digital signature 16 before installation of player software 10. When it becomes necessary to perform decryption, hardware module 3 is asked whether the hardware module has software key 18. If the hardware module does not have software key 18, an inquiry is issued to the server 201 to obtain the key.

As shown in FIG. 9, through installation, the UI component program 504 is stored on hard disk 204a for OS1, and a system boot program 342, cryptographic software 343 and digital signature 344 are stored on hard disk 204b for OS2. System boot program 342 has a function for decrypting cryptographic software 343 for execution thereof. The cryptographic software is arranged in an encrypted form in various files of player software 10, including player control program 503. Cryptographic software 343 and digital signature 344 may be written onto hard disk 204a for OS1. In addition, it is not required that these files be discrete, but they may be arranged in partitioned structures contained in one file.

If player software 10 is provided in a non-encrypted form, it is only necessary to write UI component program 504 onto hard disk 204a for OS1 and to write the plain text software proper and digital signature 344 onto hard disk 204b for OS2. Digital signature 344 may be incorporated in the installation software in advance according to one method; a new digital signature may be generated at the time of installation according to another method; or a combination of these methods may be applicable. For generating a new digital signature at the time of installation, a hash value is calculated after installation, and that value is sent to hardware module 3 for encryption using private key 301, which resides in the hardware module. Thus, a new digital signature (corresponding to digital signature 344) can be generated.

A one-to-one correspondence for files written in hard disks 204a and 204b for OS1 and OS2 is not required. That is, a one-to-one correspondence is not required for UI component program 504 and system boot program 342/cryptographic software 343. Since UI component program 504 is used to provide an interface with user 11, security protection is not affected even if UI component program 504 is altered or replaced. Where the interface of the software running on OS2 is disclosed, each user is free to create a UI component program as required.

License Agreement on Player Software

The license agreement for player software 10 can be completed in different ways depending upon whether the player software is provided in an encrypted or non-encrypted form. When player software 10 is provided in encrypted form, it is possible to complete a license agreement at the time of receiving the decryption key corresponding to the player software. When player software 10 is provided in non-encrypted form and a license agreement is necessary, a digital signature is assigned when a license agreement has been completed for player software 10.

Key control program 19 generates the digital signature using private key 301 in hardware module 3, and writes the digital signature onto the hard disk or the hardware module. When a license agreement is arranged, the digital signature is also rewritten. The digital signature prevents illegal use of player software 10 by user 11.

Startup of Player Software

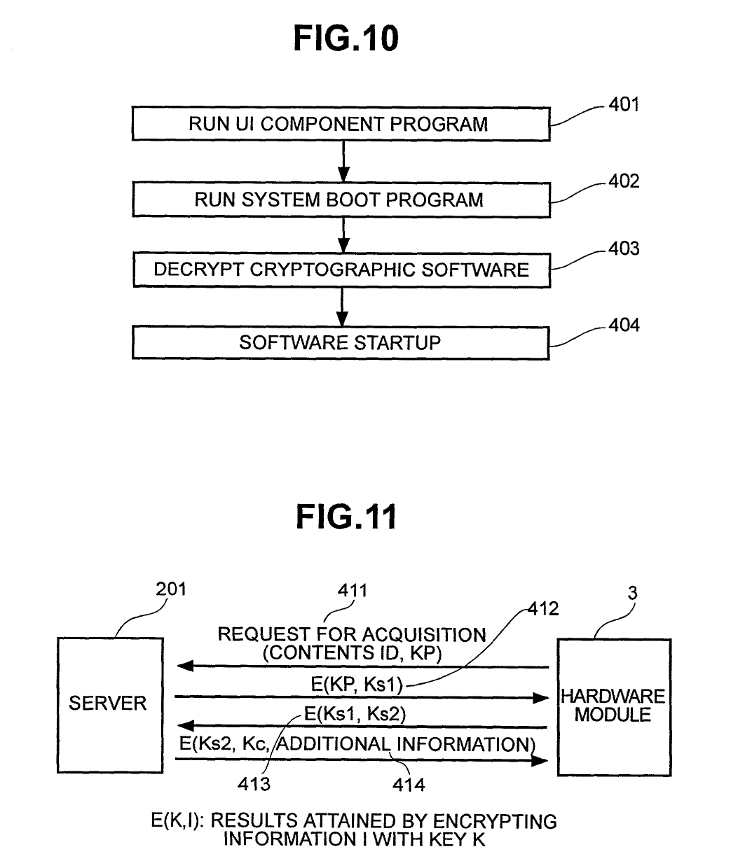

FIG. 10 is a flowchart showing the startup process for of player software 10. At step 401, user 11 runs UI component program 504. During execution of the UI component program, a command for activating system boot program 342 is written into OS2 reference region 9. UI component program 504 can be activated by using file management software or by clicking an on-screen icon thereof.

At step 402, communication control program 501 refers to OS2 reference region 9 to activate system boot program 342. At step 403, system boot program 342 extracts software key 18 from hardware module 3 for decrypting cryptographic software 343. Thus, the cryptographic software 343 is decrypted and divided among player control program 503 and various configuration files. In the above sequence, hardware module 3 authenticates system boot program 342 using digital signature 344, in the same manner as described in connection with step 1304. If authentication is successful, software key 18 is passed to system boot program 342 according to the command concerned.

More specifically, before execution of the command, hardware module 3 sends authentication program 5 to the internal memory of the PC. Authentication program 5 calculates hash values for system boot program 342 and cryptographic software 343, and sends the calculation results and digital signature 344 to hardware module 3. Then, key management program 19 performs authentication using the results of calculation, digital signature 344, and public key 302. If authentication is successful, software key 18 is passed to system boot program 342, and control goes to the next step. If the authentication is not successful, an error message is given to system boot program 342 to abort the startup.

Authentication of system boot program 342 may also be performed by a device driver of hardware module 3 or by an authentication program in OS2. Even if a part of cryptographic software 343 is encrypted, decryption of the encrypted part may not be required at the time of startup or a certain function may be unusable according to the conditions for use. In such a case, player software 10 is started up leaving the encrypted part intact, and the encrypted part is decrypted later, as required, if the conditions for use are satisfied.

At step 404, player control program 503 reads the configuration files, and sends a message to UI component program 504 that startup of player software 10 has been completed. When the UI component program 504 receives this message, player software 10 is ready for operation by the user.

Control of Player Software

After startup of player software 10, a command for controlling player control program 503 from OS1 is added to command list 502 by player control program 503. The command added at this step is a temporary command written by the player control program 503, and is removed from command list 502 at the end of execution. UI component program 504 receives an operational instruction (e.g., digital contents playback/stop, contents title selection) from user 11, and writes a control command for player control program 503 into OS2 reference region 9. The command written in OS2 reference region 9 is read out by communication control program 501. If the command thus read out by communication control program 501 matches one of the commands contained in command list 502, communication control program 501 passes the command to player control program 503. If the command read out by control program 501 does not match any of the commands contained in command list 502, communication control program 501 writes an error message into OS2 reference region 9. Then, the error message is passed to UI component program 504, which notifies user 11 of the error with a visual or audible indication using a function of OS1.

When player control program 503 receives the command from communication control program 501, player control program carries out the command. If necessary, player control program 503 delivers screen or audio output as a result of the command execution. OS2 provides device control for screen or audio output.

Multi-OS control program 8 has exclusive control over OS1 and OS2, makes possible their access to the devices used for screen and audio output (e.g., sound board, video board). More specifically, multi-OS control program 8 manages the control of the devices, themselves. When it becomes necessary for each OS to use one of the devices, an interrupt is issued to multi-OS control program 8, which performs a changeover of device control.

Distribution of Digital Content

Digital content may be distributed in a variety of ways using removable media, communication media, or broadcast media. When digital content is available on a billable basis or when any limitation is imposed on the playback of digital content, an encrypted form of the digital content is used for distribution. In distribution of encrypted digital content, encryption is made with a key unique to the digital content (content key 17). The memory area managed by OS1 or OS2 or hardware module 3 may be used for storing digital content in the PC.

Digital content distributed through communication or broadcast media can be stored in the OS2 memory area or in hardware module 3 by downloading software having the same structure as that of the player software, and the digital content can be stored at the time of the download. In addition, the use of file management software having the same structure as that of the player software facilitates the transfer of digital content held in the OS1 memory area into the OS2 memory area or into hardware module 3 by enabling the digital content to be moved or copied to those storage locations content

Furthermore, through use of the above file management software, a file held in the OS2 memory area or in hardware module 3 can be managed from the OS1 side. More specifically, the content of a file held in the OS2 memory area or in hardware module 3 cannot be changed, but user 11 can select desired content for playback using player software 10 or can rename the file.

Obtaining the Contents Key

FIG. 11 shows a procedure for obtaining the contents key 17. At step 411, the player software 10, which is used to play encrypted digital contents, sends the public key 302 (KP) unique to hardware module 3, the public key certificate information (which may be stored with public key 302), and the ID information for the digital contents to server 201.

Then, using the public key certificate information, server 201 verifies the hardware module 3 for authentication. At step 412, server 201 generates a temporary session key Ks1 (symmetric key) and sends data encrypted using the received public key 302 (KP) to the PC of user 11. On the PC of user 11, player software 10 receives the encrypted data and supplies it to the hardware module 3.

At step 413, the key management program in hardware module 3 decrypts the encrypted data using private key 301 to attain the session key Ks1, generates a temporary session key Ks2 (symmetric key), encrypts session key Ks2 using session key Ks1, and sends the encrypted session key Ks2 to the server 201. At step 414, server 201 decrypts the encrypted session key Ks2 using session key Ks1 to obtain session key Ks2, encrypts the contents key 17 (Kc) and additional information (such as conditions of use information) using session key Ks2, and sends the encrypted contents key 17 (Kc) and additional information to the PC of user 11.

The conditions of use information includes information regarding the use period of the key. In a situation where it is required for server 201 to send only contents key 17 (Kc), the server 201 may encrypt the contents key using public key 302 (KP) and send the encrypted contents key 17 (Kc) to the PC of user 11. On the PC of user 11, player software 10 writes the received data into hardware module 3 or onto the hard disk of the PC. Where the received data is written into hardware module 3, encryption is not necessary, and, therefore, the received data may be decrypted in the hardware module, using session key Ks2, and stored there.

In contrast, where the received data is written onto the hard disk of the PC, an encrypted form thereof is stored on the hard disk, whereas session key Ks2 is stored in hardware module 3. In this case, there may be an arrangement whereby encrypted contents key 17 (Kc) and additional information are decrypted once using session key Ks2 and then a new key is generated for re-encrypting contents key 17 (Kc) and additional information.

Playback of Digital Contents

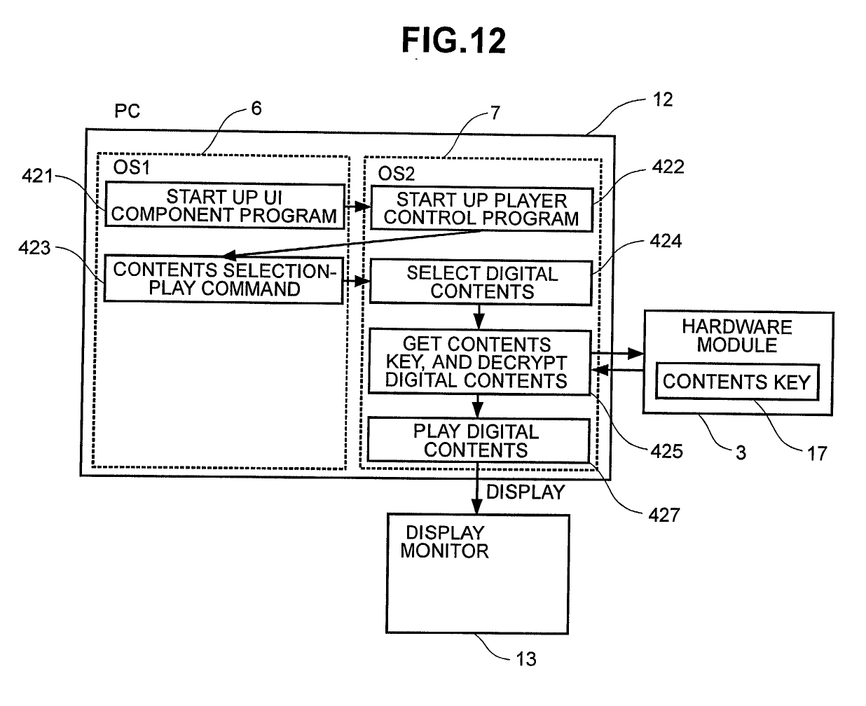

FIG. 12, shows a flow of operations for playing digital contents. At step 421, in response to an instruction from user 11, UI component program 504 writes a startup command to activate system boot program 342 in OS2 reference region 9. At step 422, communication program 501 reads the startup command from OS2 reference region 9 and starts up system boot program 342, which decrypts cryptographic software 343 and starts up player control program 503.

At step 423, user 11 uses UI component program 504 to select the digital contents for playback. UI component program 504 then writes that information into OS2 reference region 9. At step 424, communication control program 501 receives the information regarding the selection and passes it to player control program 503, which loads the digital contents corresponding to the selection from the hard disk into the internal memory of the PC.

At step 425, if the digital contents are in an encrypted form, player control program 503 asks hardware module 3 whether the contents key that corresponds to the digital contents is stored in the module. If contents key 17 is not found, player control program 503 lets user 11 determine whether to abort playback or to obtain the key from the server.

When user 11 chooses to obtain contents key 17, an inquiry is issued to server 201 to get contents key 17. After contents key 17 is obtained, a request to extract the contents key is sent from player control program 503 to hardware module 3. Key management program 19 in hardware module 3 checks an indicated condition for use in additional information file 305. If the condition is satisfied, key management program 19 passes contents key 17 to player control program 503. Using the contents key 17 thus received, player control program 503 decrypts the digital contents. If the digital contents are not in an encrypted form, control goes to step 427.

At step 427, player control program 503 plays the digital contents. When the digital contents are video images, player control program 503 outputs the video images onto display monitor 13. Further, when sound is included in the digital contents, player control program 503 delivers sound output to a speaker (not shown). As described above, the present invention makes it possible to prevent illegal alteration and analysis of computer software.

Furthermore, according to the preferred embodiment, a semiconductor device and a physical device such as a CPU in a PC preferably has a private key and a public key stored in a tamper-resistant internal memory area thereof, and, at the time of data transmission/reception, a public key exchange and a session key transfer are performed and data is encrypted with a session key. In this way, the possibility that data running through a circuit bus may be illegally extracted can be eliminated. Thus, illegal alteration and analysis of software can be safely prevented.

Further, where the CPU or each device does not output its private key outside the user's system, and programs and data are stored on a hard disk, it is preferable to perform encryption using the public key in the CPU and decryption using the private key in the CPU at the time of a read operation. The present invention also provides application software and an operating environment resistant to illegal or unauthorized alteration, operation and analysis.

Because analysis and alteration of application software by an unauthorized user can be prevented, it is possible to protect a copyright on the digital contents which are played using the player software therefor. Thus, an author can provide high-quality digital contents without worrying about an infringement of a copyright such as illegal duplication. Each user can enjoy high-quality digital contents on a PC and can upgrade a software version economically. Therefore, the latest functions and services constantly become available to each user.

A hardware manufacturer can reduce production cost in comparison to the cost of providing dedicated hardware and can promptly supply new products and services to users. In addition, with the present invention, use of a removable type of storage medium such as an IC card, enables a user to play digital contents for which the right to playback has been granted on another PC or portable device. As described above and according to the present invention, a software product and a system for running the same can be provided in a tamper-resistant arrangement. The specification and drawings are, accordingly, to be regarded in an illustrative rather than a restrictive sense. Those skilled in the art will appreciate that various modifications and changes may be made to the exemplary embodiment without departing from the broader spirit and scope of the invention as set forth in the claims.

What is claimed is:

1. A tamper-resistant computer system having a CPU and a main memory for executing application software, comprising:
a first operating system; and
a second operating system;
wherein the application software comprises a first component program executed by the first operating system, and a second component program executed by the second operating system, wherein the first component program has a user interface for receiving an operational instruction from a user of the computer system and for issuing a command to the second component program, and
wherein the second component program performs the command issued by the first component program if execution thereof has been designated as permitted in advance, thereby preventing the second component program from being accessed by the user.

2. A tamper-resistant computer system as claimed in claim 1, further comprising a communication control program that sends a command issued by the first component program to the second component program if execution thereof is permitted.

3. A tamper-resistant computer system as claimed in claim 2, further comprising a multi-OS control program for controlling the first and second operating systems;
wherein the multi-OS control program establishes a particular region in a memory area managed by the first operating system so that the particular region can be referred to by the communication control program, wherein the user interface of the first component program writes the command into the particular region for issuance thereof, and
wherein, by referring to the particular region, the communication control program reads a command stored in the particular region by the first component program, and then, by making reference to a list of the permitted commands held in a memory area managed by the second operating system, the communication control program sends the command to the second component program if the command is in the list.

4. A tamper-resistant computer system as claimed in claim 3 further including a tamper-resistant hardware module for storing a system boot program;
wherein the tamper-resistant computer system includes an initial program for reading the system boot program at system startup,
wherein the system boot program includes a function for executing the multi-OS control program, and wherein the multi-OS control program includes a function for executing the first and second operating systems.

5. A tamper-resistant computer system as claimed in claim 4,
wherein the second component program comprises a system boot program, cryptographic software, and digital signature, wherein the hardware module includes a decryption key for the cryptographic software and a function for authenticating the system boot program,
wherein the system boot program includes a function for performing authentication for the hardware module, a function for extracting the decryption key for the cryptographic software from the hardware module, and a function for decrypting the cryptographic software with the decryption key extracted from the hardware module, and
wherein, according to a command from the first component program, the system boot program is executed, and in response the cryptographic software is decrypted and executed.

6. A tamper-resistant computer system as claimed in claim 5 wherein the hardware module further includes a decryption key for cryptographic data to be used by the second component program, and wherein the second component decrypts the cryptographic data.

7. A tamper-resistant computer system as claimed in claim 3,
wherein, at start of the second component program, the second component program adds a command permitted for the first component program to the list of permitted commands, and
wherein, at the time of termination of the second component program, the second component program removes the command from the list of permitted commands.

8. A tamper-resistant computer system as claimed in claim 1, wherein the second component program comprises a command processing program for command execution, and a communication control program through which a command issued by the first component program is sent to the command processing program if execution thereof is permitted.

9. A method for installing system software onto a tamper-resistant computer system comprising:
providing an installation program for system software which includes an installation start program, a cryptographic system file, and a digital signature, and wherein the installation start program includes a function for extracting a decryption key for the cryptographic system file from the hardware module and a function for decrypting the cryptographic system file with the decryption key extracted from the hardware module; and
executing the installation start program; and decrypting the cryptographic system file.

10. A method as in claim 9, wherein the method further comprises:
providing an installation program for application software which installation program includes a first installation program executed by a first operating system and a second installation program executed by a second operating system; wherein the first installation program includes a function for writing a first component program into a memory area managed by the first operating system and a function for calling the second installation program, wherein the second installation program has a function for writing the second component program into a memory area managed by the second operating system;
executing the first installation program;
calling the second installation program; and
executing the second installation program.

11. A method as in claim 9, wherein the installation program for the application software includes a digital signature, and a step is performed of checking the digital signature before writing the first and second component programs into the memory areas.
